(19) United States
(12) Patent Application Publication
(10) Pub. No.: US 2024/0223796 A1
(43) Pub. Date: Jul. 4, 2024

(54) LOCAL GLOBAL PREDICTION MODES WITH PROJECTED MOTION FIELDS

(71) Applicant: GOOGLE LLC, Mountain View, CA (US)

(72) Inventors: Debargha Mukherjee, Cupertino, CA (US); Mohammed Golam Sarwer, San Jose, CA (US); Rachel Barker, Cambridge (GB); Jianle Chen, San Diego, CA (US); Xiang Li, Saratoga, CA (US)

(21) Appl. No.: 18/390,238

(22) Filed: Dec. 20, 2023

Related U.S. Application Data
(60) Provisional application No. 63/436,533, filed on Dec. 31, 2022.

(51) Int. Cl. H04N 19/52; H04N 19/109; H04N 19/139; H04N 19/17; H04N 19/176; H04N 19/184

(52) U.S. Cl. CPC H04N 19/52; H04N 19/109; H04N 19/139; H04N 19/17; H04N 19/176; H04N 19/184

(57) ABSTRACT

Coding using local global prediction modes with projected motion fields includes identifying a current frame, identifying a current reference frame, obtaining a projected motion field, for the current frame, using motion data from the current reference frame, identifying a current superblock from the current frame, obtaining reference warp motion parameters for the current superblock by fitting the projected motion field to a warp motion model, and using the reference warp motion parameters to code respective blocks from the superblock.

### CROSS-REFERENCE TO RELATED APPLICATION(S)

This application claims priority to and the benefit of U.S. Provisional Application Patent Ser. No. 63/436,533, filed Dec. 31, 2022, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using local global prediction modes with projected motion fields.

Variations in these and other aspects will be described in additional detail hereafter.

An aspect is a method for encoding using local global prediction modes with projected motion fields. Encoding using local global prediction modes with projected motion fields includes obtaining an input video stream, generating encoded frame data, including the encoded frame data in an encoded bitstream, and outputting the encoded bitstream. Generating the encoded frame data includes obtaining a current frame from the input video stream, identifying a current reference frame, obtaining a projected motion field, for the current frame, using motion data from the current reference frame, identifying a current superblock from the current frame, obtaining reference warp motion parameters for the current superblock by fitting the projected motion field to a warp motion model, obtaining motion parameters, for the current block, by adding the reference warp motion parameters and the differential motion parameters, obtaining an encoded block by encoding the current block in accordance with the motion parameters, obtaining encoded differential motion parameters, for a current block from the current superblock, by encoding a result of subtracting the reference warp motion parameters from the motion parameters, and including the encoded block and the encoded differential motion parameters in the encoded frame data.

Another aspect is an apparatus for encoding using local global prediction modes with projected motion fields, the apparatus comprising a memory including computer executable instructions for encoding an input video stream, and a processor that executes the instructions to obtain an input video stream, generate encoded frame data, include the encoded frame data in an encoded bitstream, and output the encoded bitstream. To generate the encoded frame data the processor executes the instructions to obtain a current frame from the input video stream, identify a current reference frame, obtain a projected motion field, for the current frame, using motion data from the current reference frame, identify a current superblock from the current frame, obtain reference warp motion parameters for the current superblock, wherein, to obtain the reference warp motion parameters, the processor executes the instructions to fit the projected motion field to a warp motion model, obtain motion parameters, for the current block, wherein, to obtain the motion parameters, the processor executes the instructions to add the reference warp motion parameters and the differential motion parameters, obtain an encoded block by encoding the current block in accordance with the motion parameters, obtain encoded differential motion parameters, for a current block from the current superblock, wherein, to obtain the encoded differential motion parameters, the processor executes the instructions to encode a result of subtracting the reference warp motion parameters from the motion parameters, and include the encoded block and the encoded differential motion parameters in the encoded frame data.

Another aspect is a non-transitory computer-readable storage medium, having stored thereon an encoded bitstream, the encoded bitstream generated by performing operations comprising encoding using local global prediction modes with projected motion fields. Encoding using local global prediction modes with projected motion fields includes obtaining an input video stream, generating encoded frame data, including the encoded frame data in an encoded bitstream, and outputting the encoded bitstream. Generating the encoded frame data includes obtaining a current frame from the input video stream, identifying a current reference frame, obtaining a projected motion field, for the current frame, using motion data from the current reference frame, identifying a current superblock from the current frame, obtaining reference warp motion parameters for the current superblock by fitting the projected motion field to a warp motion model, obtaining motion parameters, for the current block, by adding the reference warp motion parameters and the differential motion parameters, obtaining an encoded block by encoding the current block in accordance with the motion parameters, obtaining encoded differential motion parameters, for a current block from the current superblock, by encoding a result of subtracting the reference warp motion parameters from the motion parameters, and including the encoded block and the encoded differential motion parameters in the encoded frame data.

Another aspect is a method for decoding using local global prediction modes with projected motion fields. Decoding using local global prediction modes with projected motion fields includes obtaining an encoded bitstream, generating reconstructed frame data, including the reconstructed frame data in an output video stream, and outputting the output video stream. Generating the reconstructed frame data includes identifying a current frame, identifying a current reference frame, identifying a current superblock from the current frame, obtaining a projected motion field, for the current superblock, using motion data from the current reference frame, obtaining reference warp motion parameters for the current superblock by fitting the projected motion field to a warp motion model, obtaining differential motion parameters, for a current block from the current superblock, from the encoded bitstream, obtaining motion parameters, for the current block, by adding the reference warp motion parameters and the differential motion parameters, obtaining a predicted block for the current block in accordance with the motion parameters, obtaining a reconstructed block by adding the predicted block and a reconstructed residual block obtained by decoding residual data for the current block from the encoded bitstream, and including the reconstructed block in the reconstructed frame data.

Another aspect is an apparatus for decoding using local global prediction modes with projected motion fields, the apparatus comprising a memory including computer executable instructions for decoding an encoded video stream, and a processor that executes the instructions to obtain an encoded bitstream, generate reconstructed frame data, include the reconstructed frame data in an output video stream, and output the output video stream. To generate the reconstructed frame data the processor executes the instructions to identify a current frame, identify a current reference frame, obtain a projected motion field, for the current frame, using motion data from the current reference frame, identify a current superblock from the current frame, obtain reference warp motion parameters for the current superblock, wherein, to obtain the reference warp motion parameters, the processor executes the instructions to fit the projected motion field to a warp motion model, obtain differential motion parameters, for a current block from the current superblock, from the encoded bitstream, obtain motion parameters, for the current block, wherein, to obtain the motion parameters, the processor executes the instructions to add the reference warp motion parameters and the differential motion parameters, obtain a predicted block for the current block in accordance with the motion parameters, obtain a reconstructed block, wherein, to obtain the reconstructed block, the processor executes the instructions to add the predicted block and a reconstructed residual block obtained by decoding residual data for the current block from the encoded bitstream, and include the reconstructed block in the reconstructed frame data.

Another aspect is a non-transitory computer-readable storage medium having stored thereon an encoded bitstream, wherein the encoded bitstream is configured for decoding by operations comprising decoding using local global prediction modes with projected motion fields. Decoding using local global prediction modes with projected motion fields includes obtaining an encoded bitstream, generating reconstructed frame data, including the reconstructed frame data in an output video stream, and outputting the output video stream. Generating the reconstructed frame data includes identifying a current frame, identifying a current reference frame, obtaining a projected motion field, for the current frame, using motion data from the current reference frame, identifying a current superblock from the current frame, obtaining reference warp motion parameters for the current superblock by fitting the projected motion field to a warp motion model, obtaining differential motion parameters, for a current block from the current superblock, from the encoded bitstream, obtaining motion parameters, for the current block, by adding the reference warp motion parameters and the differential motion parameters, obtaining a predicted block for the current block in accordance with the motion parameters, obtaining a reconstructed block by adding the predicted block and a reconstructed residual block obtained by decoding residual data for the current block from the encoded bitstream, and including the reconstructed block in the reconstructed frame data.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flowchart diagram of an example of encoding using local global prediction modes with projected motion fields in accordance with implementations of this disclosure.

FIG. 8 is a block diagram of an example of a method of obtaining a projected motion field.

FIG. 9 is a block diagram of an example of another method of obtaining a projected motion field.

FIG. 10 is a flowchart diagram of an example of decoding using local global prediction modes with projected motion fields in accordance with implementations of this disclosure.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Some block-based hybrid video coding techniques, or codecs, may be limited to reducing temporal redundancy using a translational motion model, which may inefficiently or inaccurately represent non-translational motion. Some block-based hybrid video coding techniques, or codecs, may include warped motion video coding, including warped motion compensation, which may improve the efficiency, accuracy, or both, relative to block-based hybrid video coding techniques that are limited to reducing temporal redundancy using a translational motion model, with respect to non-translational motion. For example, some block-based hybrid video coding techniques may include warped motion video coding using a global warp motion model, a local warp motion model, or both.

Some block-based hybrid video coding techniques, or codecs, which include warped motion video coding may signal warped motion model parameters inefficiently. For example, some block-based hybrid video coding techniques, or codecs, which include warped motion video coding may signal warped motion model parameters, such as global affine motion parameters, on a per-frame or a per-group-of-frames basis. Some block-based hybrid video coding techniques, or codecs, which include warped motion video coding may omit signaling warped motion model parameters, such as warped motion model parameters for a local warp motion model.

The encoding and decoding using local global prediction modes with projected motion fields described herein improves on video coding techniques, or codecs, by signaling warped motion model parameters at the superblock, or superblock group, level, wherein the resource utilization associated with signaling warped motion model parameters at the superblock, or superblock group, level is reduced by temporal propagation of the motion field.

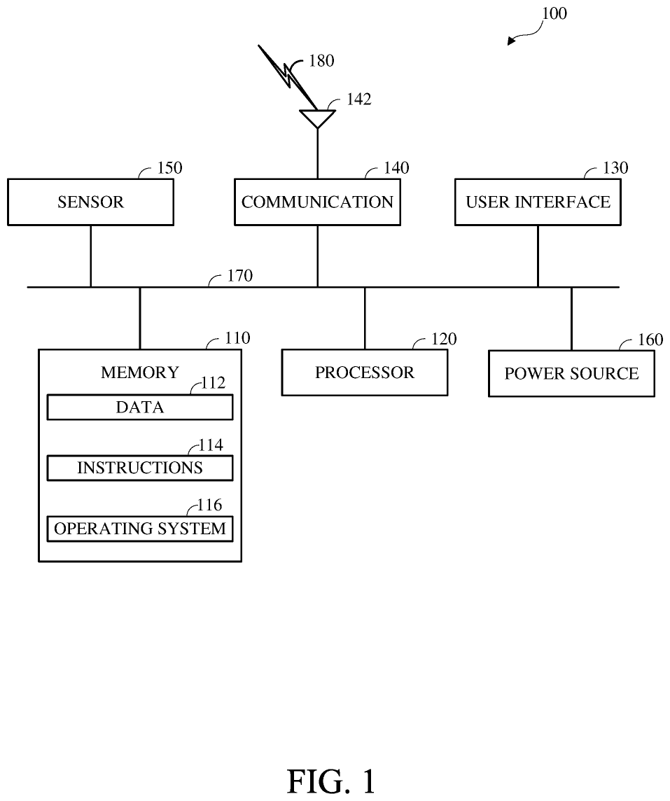

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, that may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

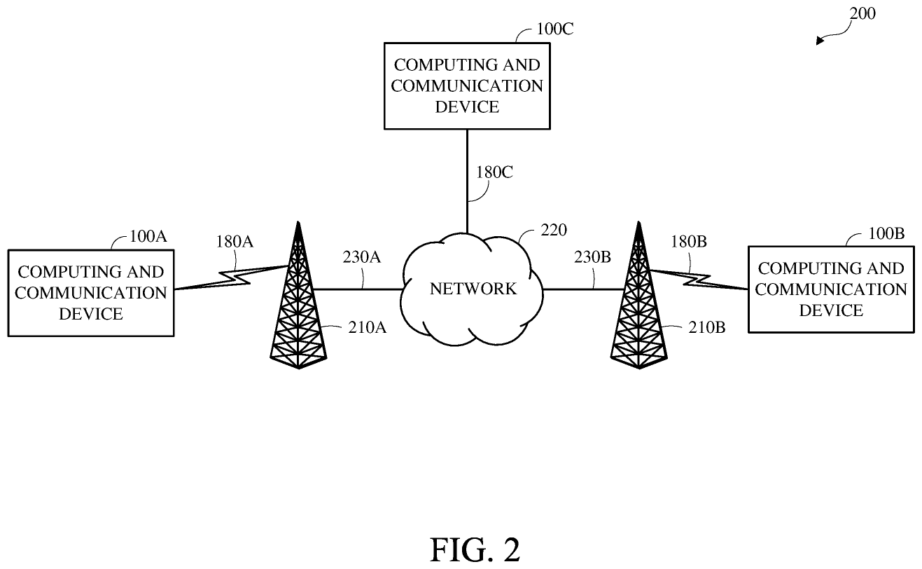

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

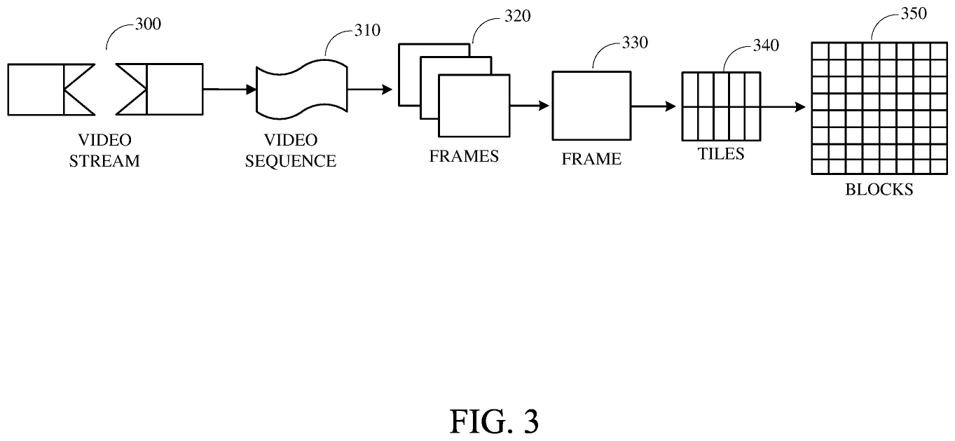

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

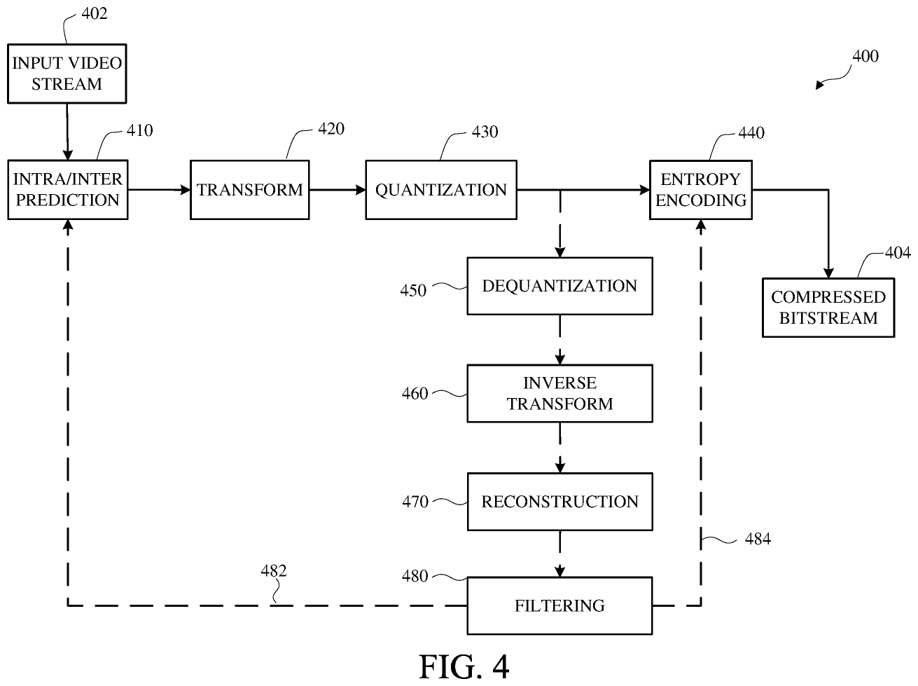

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

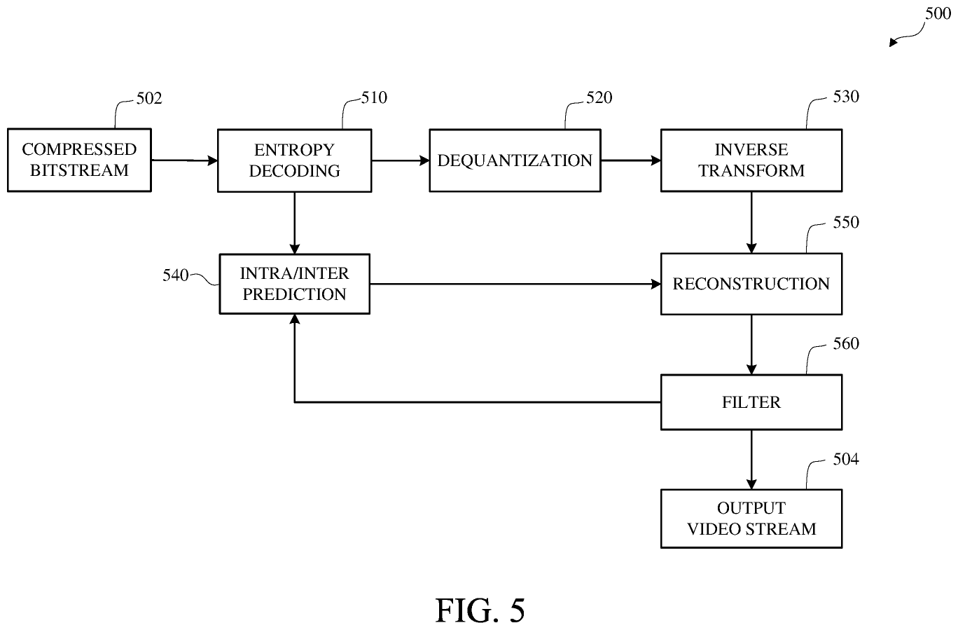

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the filtering unit 560.

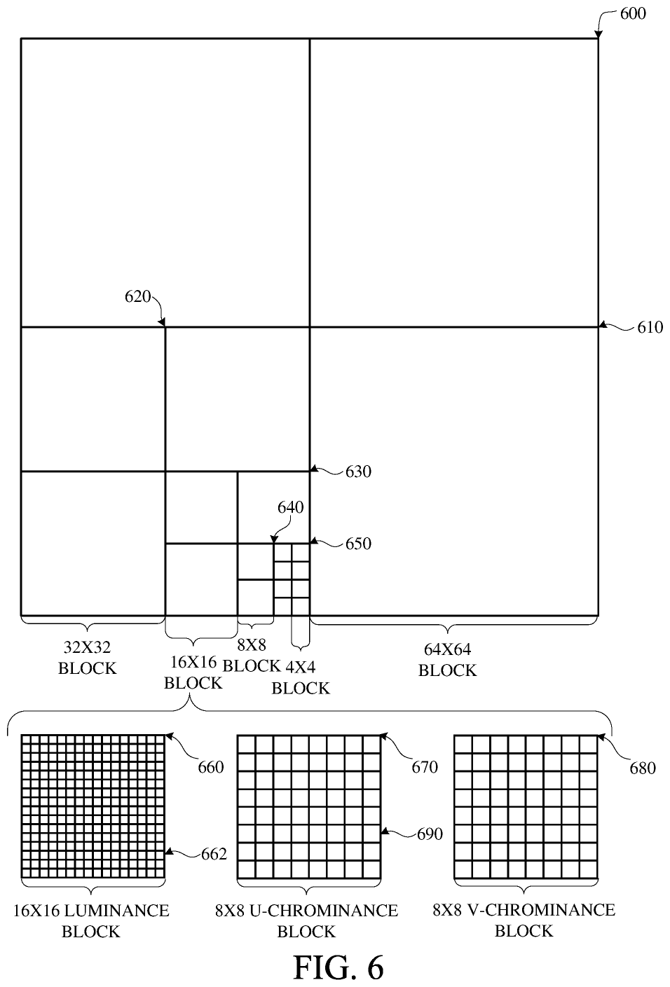

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x, y}. Similarly, a pixel of the search area of the reference frame may be indicated based on location using Cartesian coordinates as r_{x, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

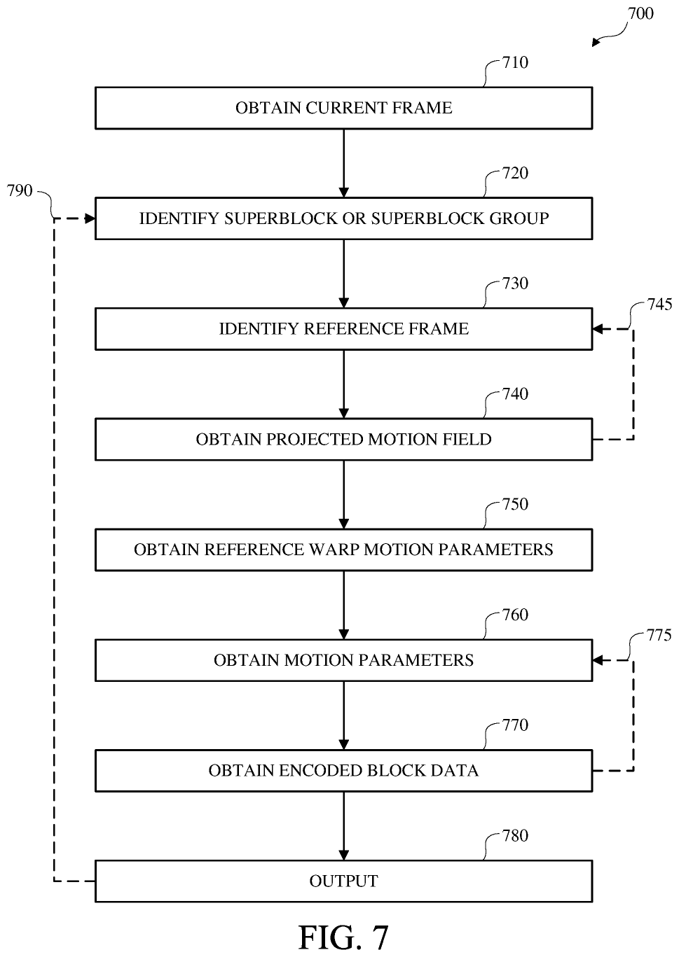

FIG. 7 is a flowchart diagram of an example of encoding using local global prediction modes with projected motion fields 700 in accordance with implementations of this disclosure. Encoding using local global prediction modes with projected motion fields 700 may be implemented in an encoder, such as the encoder 400 shown in FIG. 4.

Encoding using local global prediction modes with projected motion fields 700 includes encoding an input video steam, such as the input video stream 402 shown in FIG. 4, or one or more portions thereof, to generate an encoded (compressed) output bitstream, such as the encoded (compressed) bitstream 404 shown in FIG. 4. In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data. For example, spatial redundancy may be reduced using intra prediction, wherein the current block is predicted from the current frame. In another example, temporal redundancy may be reduced using inter prediction, wherein the current block is predicted from one or more reference frames, which may be previously decoded (and reconstructed) frames, constructed reference frames, or both.

Motion, other than translational motion, which may be inaccurately represented using translational motion vectors, may be expressed in accordance with a warped motion model, such as a homographic warped motion model, an affine warped motion model, a similarity warped motion model, or another warped motion model.

A homographic warped motion model includes eight parameters to indicate displacement between pixels of the current block and pixels of the reference frame, such as in a quadrilateral portion of the reference frame, for generating a prediction block. A homographic warped motion model may represent translation, rotation, scaling, changes in aspect ratio, shearing, and other non-parallelogram warping.

An affine warped motion model includes six-parameters to indicate displacement between pixels of the current block and pixels of the reference frame, such as in a parallelogram portion of the reference frame, for generating a prediction block. An affine warped motion model is a linear transformation between the coordinates of two spaces represented by the six-parameters. An affine warped motion model may represent translation, rotation, scale, changes in aspect ratio, and shearing. The parameters of the affine warped motion model include a first pair of parameters (h₁₃, h₂₃) that represent translational motion (translational parameters), such a horizontal translational motion parameter (h₁₃) and a vertical translational motion parameter (h₂₃). The parameters of the affine warped motion model include a second pair of parameters (h₁₁, h₂₂) that represent scaling (scaling parameters), such a horizontal scaling parameter (h₁₁) and a vertical scaling parameter (h₂₂). The parameters of the affine warped motion model include a third pair of parameters (h₁₂, h₂₁) that, in conjunction with the scaling parameters, represent angular rotation (rotation parameters). For example, for a current pixel at position (x,y) from the current frame, a corresponding position (x′, y′) from the reference frame may be indicated using the affine warped motion model, which may include a horizontal displacement (x′) for encoding the current block that is a result of adding a result of multiplying the horizontal scaling parameter by the current horizontal position, a result of multiplying the first rotation parameter by the current vertical position, and the horizontal translational motion parameter, and a vertical displacement (y′) for encoding the current block that is a result of adding a result of multiplying the vertical scaling parameter by the current horizontal position, a result of multiplying the second rotation parameter by the current vertical position, and the vertical translational motion parameter, which may be expressed as the following:

$${x}^{′} = {h}_{11} x + {h}_{12} y + {h}_{13} , \qquad [ Equation 1 ]$$

$${y}^{′} = {h}_{21} x + {h}_{21} y + {h}_{23} . \qquad [ Equation 2 ]$$

A similarity warped motion model includes four-parameters to indicate displacement between pixels of the current block and pixels of the reference frame, such as in a square portion of the reference frame, for generating a prediction block. A similarity warped motion model is a linear transformation between the coordinates of two spaces represented by the four-parameters. For example, the four-parameters can be a translation along the x-axis, a translation along the y-axis, a rotation value, and a zoom value. A similarity warped motion model may represent square-to-square transformation with rotation and zoom. The parameters of the similarity warped motion model include a first pair of parameters (h₁₃, h₂₃) that represent translational motion (translational parameters), such a horizontal translational motion parameter (h₁₃) and a vertical translational motion parameter (h₂₃). The parameters of the similarity warped motion model include a second parameter (h₁₁) that represent scaling (scaling parameter) (h₂₂=h₁₁). The parameters of the similarity warped motion model include a third parameter (h₂₁) that, in conjunction with the scaling parameter, represent angular rotation (rotation parameter) (h₁₂=h₂₁). For example, for a current pixel at position (x,y) from the current frame, a corresponding position (x′, y′) from the reference frame may be indicated using the similarity warped motion model, which may include a horizontal displacement (x′) for encoding the current block that is a result of adding a result of subtracting a result of multiplying the rotation parameter by the current vertical position, from a result of multiplying the horizontal scaling parameter by the current horizontal position, and the horizontal translational motion parameter, and a vertical displacement (y′) for encoding the current block that is a result of adding a result of multiplying the rotation parameter by the current horizontal position, a result of multiplying the horizontal scaling parameter by the current vertical position, and the vertical translational motion parameter, which may be expressed as the following:

$${x}^{′} = {h}_{11} x - {h}_{21} y + {h}_{13} , \qquad [ Equation 3 ]$$

$${y}^{′} = {h}_{21} x + {h}_{11} y + {h}_{23} . \qquad [ Equation 4 ]$$

The parameters of a warped motion model, other than the translational parameters, are non-translational parameters. In some implementations, a global warp model, which may represent frame level scaling and rotation, which may correspond with rigid motion, which may be associated with a respective reference frame, may be used, which may include expressing the non-translational parameters (h₁₁, h₁₂, h₂₁, h₂₂) with twelve-bit (12-bit) precision and expressing the translational parameters (h₁₃, h₂₃) with fifteen-bit (15-bit) precision. In some implementations, a local, block level or causal, warp model, which may be obtained, or derived, by fitting a model to context motion vectors using least-squares, may be used.

Encoding using local global prediction modes with projected motion fields 700 includes obtaining a current frame (at 710), identifying a superblock (at 720), identifying a reference frame (at 730), obtaining a projected motion field (at 740), obtaining reference warp motion parameters (at 750), obtaining motion parameters (at 760), obtaining encoded block data (at 770), and outputting an output bitstream (at 780).

A current frame is obtained (at 710). The current frame is a frame from the input video, or input video stream. In some implementations, the input video stream may include one or more sequences of frames. A sequence of frames may have a defined cardinality, or number, of frames. For example, the encoder, or a component thereof, such as an intra/inter prediction unit of the encoder, such as the intra/inter prediction unit 410 shown in FIG. 4, may obtain the input video stream. The current frame may be obtained (at 710) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

A current superblock, or a current superblock group, is identified (at 720) from the current frame. A superblock has a size of 256×256 pixels, 128×128 pixels, or 64×64 pixels and includes smaller blocks, such as 16×16-pixel blocks, 8×8-pixel blocks, 4×4-pixel blocks, or a combination thereof. In some implementations, identifying a superblock may include identifying a superblock group that includes two or more contiguous superblocks.

A reference frame for encoding the current superblock, or a portion thereof, is identified (at 730). The previously generated reference frame, including motion data, such as motion vectors, which may be warp motion parameters, is previously stored by the encoder, such as in a reference frame buffer.

The encoder may maintain, such as store in local memory, such as in a decoded frame buffer (or reference frame buffer, or reconstructed frame buffer), one or more reconstructed frames, which may be used reference frames for inter prediction. The reconstructed reference frames may include one or more recently output, or displayed, reconstructed frames. The reconstructed reference frames may include one or more previously output, or displayed, reconstructed frames, output, or displayed, prior to outputting, or displaying, the recently output, or displayed, reconstructed frames, such as golden, or key, frames, which may be intra coded frames. The reconstructed reference frames may include one or more frames that are designated as output, or display (displayable) frames. The reconstructed reference frames may include one or more alternate, or constructed, reference frames, which may be non-displayed frames, and which may be synthesized, or constructed, by the encoder, such as using temporal filtering along the motion trajectories of multiple frames. A reference frame in the reference frame buffer may be identified, or identifiable, using an index value (reference frame index value) with respect to the reference frame buffer wherein a location, or position, in the reference frame buffer is uniquely identifiable by a respective index vale. To reduce, or minimize, the resource utilization, such as bandwidth utilization, for signaling, storing, or both, data identifying the reference frame, or reference frames, used for inter coding, the reference frame, or reference frames, may be expressed, represented, or communicated, by signaling the corresponding reference frame index value. In some implementations, the reference frame index value may be signaled differentially, wherein a difference between the reference frame index value for the current block and a reference frame index value obtained from a neighboring previously coded block is signaled.

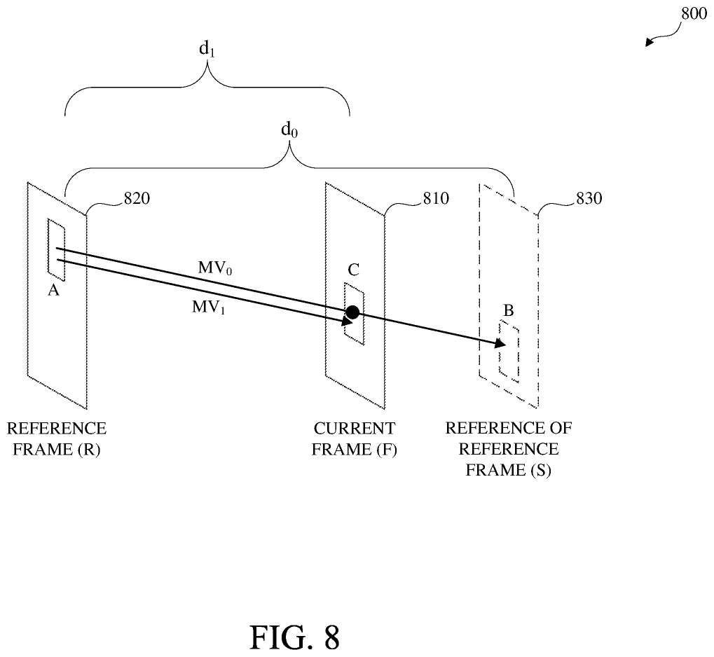

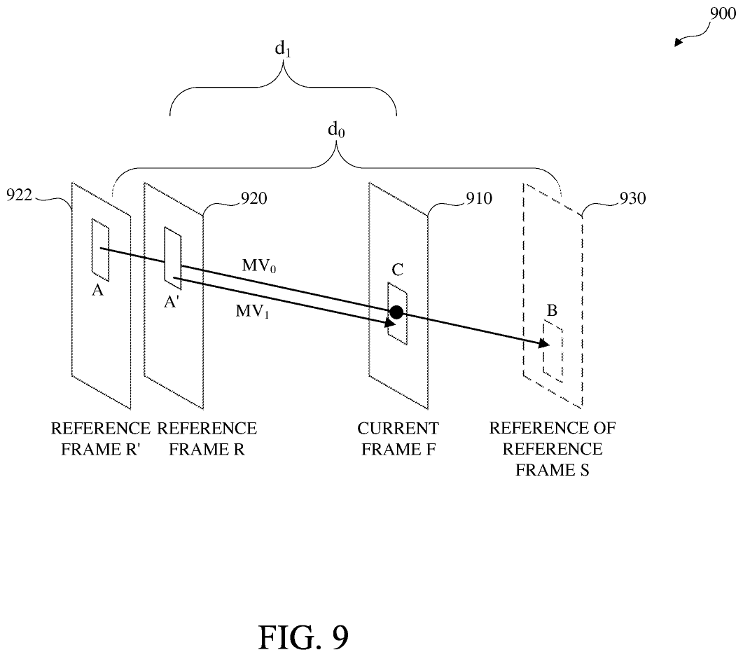

A projected motion field is obtained (at 740). The projected motion field includes optimal projected motion vectors for blocks, such as 8×8 pixel blocks, from the current superblock, or superblock group. The projected motion field may be obtained by temporal projection from the motion fields stored for the reference frames. Examples of obtaining the projected motion field are shown in FIGS. 8-9. For zero or more portions of the current frame, the projected motion field may include multiple projected motion vectors (overlaps). For zero or more portions of the current frame, projected motion vectors may be absent from the projected motion field (holes). A broken directional line is shown (at 745) between obtaining the projected motion field (at 740) and identifying a reference frame (at 730) to indicate that the projected motion field for the current reference frame may be obtained based on motion data for the current reference frame, as shown in FIG. 8, motion data for one or more other reference frames that intersects the current reference frame, as shown in FIG. 9, or a combination thereof. Although described with reference to a current superblock, or a current superblock group, the projected motion field for the current frame may be obtained independently of, such as prior to, other aspects of decoding the current frame.

Subsequent to obtaining the projected motion field (at 740) for the current superblock, or superblock group, the motion data from the projected motion field is fit to a warped motion model, such as using a regression, such as a least-squares regression, of the motion vectors of the projected motion field to a warp model, such as a similarity model, an affine model, or a perspective model, is performed to obtain reference, or predicted, warp motion parameters (at 750). Portions of the current frame for which projected motion vectors are absent from the projected motion field (holes) are omitted from, or unused in, the regression. In some implementations, such as implementations using a perspective warp model, or a stronger affine model, a translational approximation on 4×4 sub-blocks may be used to generate the reference, or predicted, warp motion parameters.

Motion parameters, such as warp motion parameters, are obtained (at 760), such as on a per-block basis for the blocks from the current superblock, or current superblock group. Obtaining the motion parameters may include searching for optimal motion parameters, such as using optical flow and regression, or using a hierarchical parameter search. Other motion estimation techniques may be used. In some implementations, the warp motion parameters may be obtained subsequent to obtaining the reference warp motion parameters (at 750). In some implementations, obtaining the warp motion parameters (at 760) may include using the reference warp motion parameters (obtained at 750) to perform motion estimation.

Encoded block data is obtained (at 770) by encoding respective blocks from the current superblock, or current superblock group, such as in accordance with the motion parameters for the respective block (obtained at 760). Obtaining the encoded block data for a block may include differentially encoding the motion parameters, such as by subtracting the reference warp motion parameters (obtained at 750) from the warp motion parameters (obtained at 760) to obtain differential warp motion parameters. In some implementations, a warp motion model type used for encoding a respective block, such as similarity, affine, perspective, or another warp motion model, is signaled. For example, a model identifier (model ID) may be encoded and included in the output bitstream. In some implementations, a relatively short code is signaled, or included in the output bitstream, to indicate that the differential warp motion parameters are zero value, such that encoding the differential warp motion parameters may be otherwise omitted. In some implementations, including the differential warp motion parameters is omitted and the reference warp motion parameters (obtained at 750) are used as the warp motion parameters. In some implementations, differentially encoding the motion parameters is omitted and the motion parameters are encoded.

In some implementations, a block, or prediction block, in the current superblock, or current superblock group, may be encoded using a global motion mode, which includes using the reference, local global, warp motion parameters (obtained at 750). In some implementations, a translational motion vector derived for a block based on the global parameters can be used as a candidate in dynamic reference lists.

A broken directional line between obtaining encoded block data (at 770) and obtaining motion parameters (at 760) is shown (at 775) to indicate that motion parameters, encoded block data, or both, are obtained on a per-block basis for the blocks in the current superblock, or the current superblock group.

The output, compressed, or encoded, bitstream, including the encoded block data, is output (at 780).

A broken directional line between output (at 780) and identifying the current superblock, or the current superblock group, (at 720) is shown (at 790) to indicate that identifying a superblock (at 720), identifying a reference frame (at 730), obtaining a projected motion field (at 740), obtaining reference warp motion parameters (at 750), obtaining motion parameters (at 760), obtaining encoded block data (at 770), including the encoded block data in the output bitstream (at 780), or a combination thereof, may be performed on a per-superblock, or per-superblock group, basis for the superblocks, or superblock groups, from the current frame.

FIG. 8 is a block diagram of an example of a method of obtaining a projected motion field 800. Obtaining the projected motion field 800 may be implemented in an encoder, such as the encoder 400 shown in FIG. 4, a decoder, such as the decoder 500 shown in FIG. 5, or both.

FIG. 8 shows a current frame (F) (810), a current reference frame (R) (820) for encoding the current frame (F) (810), and a second reference frame (S) (830) previously used for encoding a frame corresponding to the current reference frame (R) (820). The current reference frame (R) (820) temporally precedes the second reference frame (S) (830) by a first distance (d₀). The current reference frame (R) (820) temporally precedes the current frame (F) (810) by a second distance (d₁). The current frame (F) (810) temporally precedes the second reference frame (S) (830) by a third distance (d₀−d₁).

Obtaining the projected motion field 800 includes obtaining projected motion vectors for the current frame (F) (810) based on motion data, or motion field data, previously used for encoding a frame corresponding to the current reference frame (R) (820) that intersects the current frame (F) (810).

FIG. 8 shows a first motion vector (MV₀). The first motion vector (MV₀) is a motion vector previously used for encoding a first portion (A), such as a block, such as an 8×8 pixel block, of the current reference frame (R) (820), stored with the data for the current reference frame (R) (820). The previously stored data for the first motion vector (MV₀) includes a signed distanced value indicating a temporal distanced between the current reference frame (R) (820) and the second reference frame (S) (830). The first motion vector (MV₀) indicates a spatial displacement from a location of the first portion (A) in the current reference frame (R) (820) to a location of a second portion (B) in the second reference frame (S) (830). The first motion vector (MV₀) intersects, or passes through, the current frame (F) (810) at a location of a third portion (C) of the current frame (F) (810).

A projected motion vector (MV₁) is generated, determined, or otherwise obtained, based on the first motion vector (MV₀) intersecting the current frame (F) (810) at the location of the third portion (C). The projected motion vector (MV₁) indicates a spatial displacement from the location of the first portion (A) in the current reference frame (R) (820) to the location of the third portion (C) of the current frame (F) (810). Obtaining the projected motion vector (MV₁) may be expressed as MV₁=d₁/d₀*MV₀. The projected motion vector (MV₁) and the first motion vector (MV₀) are spatially overlapping and are shown in FIG. 8 as spatially offset for clarity.

Although one projected motion vector (MV₁) is shown in FIG. 8, obtaining the projected motion field 800 includes obtaining, such as by generating, one or more other projected motion vectors, respectively corresponding to the respective motion vectors previously used for encoding a frame corresponding to the current reference frame (R) (820) that intersect the current frame (F) (810). For zero or more portions of the current frame (F) (810), the projected motion field may include multiple projected motion vectors (overlaps). For portions of the current frame (F) (810) wherein the projected motion field includes multiple projected motion vectors (overlaps), one of the projected motion vectors, such as a first projected motion vector, a last projected motion vector, or an average projected motion vector, which may be weighted, may be used as the projected motion vector for the respective portion of the current frame (F) (810).

For zero or more portions of the current frame (F) (810), projected motion vectors may be absent from the projected motion field (holes), such as wherein a motion vector from the current reference frame (R) (820) to the second reference frame (S) (830) that intersects the current frame (F) (810) is absent from the motion field data from the current reference frame (R) (820).

FIG. 9 is a block diagram of an example of another method of obtaining a projected motion field 900. Obtaining the projected motion field 900 may be implemented in an encoder, such as the encoder 400 shown in FIG. 4, a decoder, such as the decoder 500 shown in FIG. 5, or both. Obtaining the projected motion field 900 as shown in FIG. 9 is similar to obtaining the projected motion field 800 as shown in FIG. 8, except as is described herein or as is otherwise clear from context.

FIG. 9 shows a current frame (F) (910), a current reference frame (R) (920) for encoding the current frame (F) (910), a second reference frame (R′) (922), and a third reference frame (S) (930) previously used for encoding a frame corresponding to second reference frame (R′) (922). The second reference frame (R′) (922) temporally precedes the third reference frame (S) (930) by a first distance (d₀). The current reference frame (R) (920) temporally precedes the current frame (F) (910) by a second distance (d₁). The second reference frame (R′) (922) temporally precedes the current reference frame (R) (920). The current frame (F) (910) temporally precedes the third reference frame (S) (930).

Obtaining the projected motion field 900 includes obtaining projected motion vectors for the current frame (F) (910) based on motion data, or motion field data, previously used for encoding a frame corresponding to the current reference frame (R) (920) that intersects the current frame (F) (910), motion data, or motion field data, previously used for encoding a frame corresponding to the second reference frame (R′) (922) that intersects the current reference frame (R) (920) and the current frame (F) (910), or a combination thereof.

FIG. 9 shows a first motion vector (MV₀). The first motion vector (MV₀) is a motion vector previously used for encoding a first portion (A), such as a block, of the second reference frame (R′) (922), stored with the data for the second reference frame (R′) (922). The previously stored data for the first motion vector (MV₀) includes a signed distanced value indicating a temporal distanced (d₀) between the second reference frame (R′) (922) and the third reference frame (S) (930). The first motion vector (MV₀) indicates a spatial displacement from a location of the first portion (A) in the second reference frame (R′) (922) to a location of a second portion (B) in the third reference frame (S) (930). The first motion vector (MV₀) intersects, or passes through, the current frame (F) (910) at a location of a third portion (C) of the current frame (F) (910). The first motion vector (MV₀) intersects, or passes through, the current reference frame (R) (920) at a location of a fourth portion (A′) of the current reference frame (R) (920).

A projected motion vector (MV₁) is generated, determined, or otherwise obtained, based on the first motion vector (MV₀) intersecting the current reference frame (R) (920) at the location of the fourth portion (A′) and intersecting the current frame (F) (910) at the location of the third portion (C). The projected motion vector (MV₁) indicates a spatial displacement from the location of the fourth portion (A′) in the current reference frame (R) (920) to the location of the third portion (C) of the current frame (F) (910). The projected motion vector (MV₁) and the first motion vector (MV₀) are spatially overlapping and are shown in FIG. 9 as spatially offset for clarity.

Although one projected motion vector (MV₁) is shown in FIG. 9, obtaining the projected motion field 900 includes obtaining, such as by generating, one or more other projected motion vectors, respectively corresponding to the respective motion vectors previously used for encoding a frame corresponding to the current reference frame (R) (920) that intersect the current frame (F) (910). For zero or more portions of the current frame (F) (910), the projected motion field may include multiple projected motion vectors (overlaps). For portions of the current frame (F) (910) wherein the projected motion field includes multiple projected motion vectors (overlaps), one of the projected motion vectors, such as a first projected motion vector, a last projected motion vector, or an average projected motion vector, which may be weighted, may be used as the projected motion vector for the respective portion of the current frame (F) (910).

For zero or more portions of the current frame (F) (910), projected motion vectors may be absent from the projected motion field (holes), such as wherein a motion vector from the current reference frame (R) (920) to the third reference frame (S) (930) that intersects the current frame (F) (910), and a motion vector from the second reference frame (R′) (922) to the third reference frame (S) (930) that intersects the current reference frame (R) (920) and the current frame (F) (910), is absent from the motion field data from the current reference frame (R) (920).

Obtaining the projected motion field 900 as shown in FIG. 9 and obtaining the projected motion field 800 as shown in FIG. 8 may be used in combination, which may increase the number, or cardinality, of projected, or candidate, motion vectors in the projected motion field relative to obtaining the projected motion field 800 as shown in FIG. 8 without obtaining the projected motion field 900 as shown in FIG. 9.

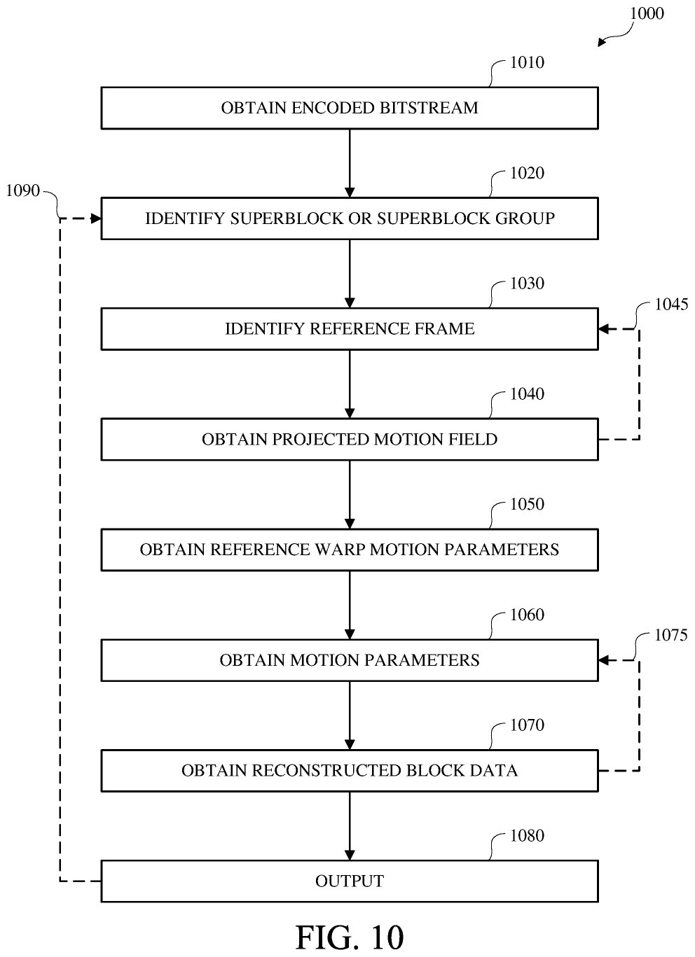

FIG. 10 is a flowchart diagram of an example of decoding using local global prediction modes with projected motion fields 1000 in accordance with implementations of this disclosure. Decoding using local global prediction modes with projected motion fields 1000 may be implemented in a decoder, such as the decoder 500 shown in FIG. 5.

Decoding using local global prediction modes with projected motion fields 1000 includes decoding an encoded bitstream, such as the compressed bitstream 502 shown in FIG. 5, or one or more portions thereof, to generate a reconstructed video, or a portion thereof, such as the output video stream 504 shown in FIG. 5.

The decoder may maintain, such as store in local memory, such as in a decoded frame buffer (or reference frame buffer, or reconstructed frame buffer), one or more reconstructed frames, which may be used as reference frames for inter prediction, which is similar to the reconstructed frame buffer maintained by the encoder as described with reference to FIG. 7, except as is described herein or as is otherwise clear from context.

Decoding using local global prediction modes with projected motion fields 1000 includes obtaining the encoded bitstream (at 1010), identifying a superblock (at 1020), identifying a reference frame (at 1030), obtaining a projected motion field (at 1040), obtaining reference warp motion parameters (at 1050), obtaining motion parameters (at 1060), obtaining reconstructed block data (at 1070), and outputting an output bitstream (at 1080).

The encoded bitstream is obtained (at 1010). Obtaining the encoded bitstream includes identifying a current frame to decode from the encoded bitstream to generate a current reconstructed frame, which includes identifying a current block from the current frame to decode from the encoded bitstream to generate a current reconstructed block to include in the current reconstructed frame. For example, the decoder, or a component thereof, such as an intra/inter prediction unit of the decoder, such as the entropy decoding unit 510 shown in FIG. 5, may obtain the input video stream. The current frame may be obtained (at 1010) subsequent to decoding one or more other frames, such as a frame sequentially preceding the current frame, and generating, or otherwise obtaining, a corresponding reconstructed frame (or frames), or one or more portions thereof, for use as a reference frame (or frames) for decoding the current frame. Although not shown separately in FIG. 10, decoding using local global prediction modes with projected motion fields 1000 may include decoding, reconstructing, or both, one or more portions of the current frame prior to decoding, reconstructing, or both, the current superblock, or the current superblock group.

A current superblock, or a current superblock group, is identified (at 1020) from the current frame. A superblock has a size of 128×128 pixels or 64×64 pixels and includes smaller blocks. In some implementations, identifying a superblock may include identifying a superblock group that includes two or more contiguous superblocks. In some implementations, a superblock group may include non-contiguous superblocks. Identifying the current superblock, or the current superblock group, (at 1020) may be similar to identifying a superblock as shown (at 720) in FIG. 7, except as is described herein or as is otherwise clear from context.

A reference frame for decoding the current superblock, or a portion thereof, is identified (at 1030). The previously generated reference frame, including motion data, such as motion vectors, which may be warp motion parameters, is previously stored by the encoder, such as in the reference frame buffer. Identifying the reference frame (at 1030) may be similar to identifying a reference frame as shown (at 730) in FIG. 7, except as is described herein or as is otherwise clear from context.

A projected motion field is obtained (at 1040). The projected motion field includes optimal projected motion vectors for blocks, such as 8×8 pixel blocks, from the current superblock, or superblock group. The projected motion field may be obtained by temporal projection from the motion fields stored for the reference frames. Examples of obtaining the projected motion field are shown in FIGS. 8-9. Obtaining the projected motion field (at 1040) may be similar to obtaining the projected motion field as shown (at 740) in FIG. 7, except as is described herein or as is otherwise clear from context.

A broken directional line is shown (at 1045) between obtaining the projected motion field (at 1040) and identifying a reference frame (at 1030) to indicate that the projected motion field for the current reference frame may be obtained based on motion data for the current reference frame, as shown in FIG. 8, motion data for one or more other reference frames that intersects the current reference frame, as shown in FIG. 9, or a combination thereof. Although described with reference to a current superblock, or a current superblock group, the projected motion field for the current frame may be obtained independently of, such as prior to, other aspects of decoding the current frame.

Subsequent to obtaining the projected motion field (at 1040) for the current superblock, or superblock group, the motion data from the projected motion field is fit to a warped motion model, such as using a regression, such as a least-squares regression, of the motion vectors of the projected motion field to a warp model, such as a similarity model, an affine model, or a perspective model, is performed to obtain reference, or predicted, warp motion parameters (at 1050). Portions of the current frame for which projected motion vectors are absent from the projected motion field (holes) are omitted from, or unused in, the regression. Obtaining the reference warp motion parameters (at 1050) may be similar to obtaining the reference warp motion parameters as shown (at 750) in FIG. 7, except as is described herein or as is otherwise clear from context.

Motion parameters, such as warp motion parameters, are obtained (at 1060), such as on a per-block basis for the blocks from the current superblock, or current superblock group. Although not expressly shown in FIG. 10, obtaining the motion parameters includes identifying a block (current block) from the current superblock, or the current superblock group.

Obtaining the motion parameters includes decoding, such as entropy decoding, encoded motion data for the current block from the encoded bitstream. Obtaining the motion parameters for the current block may include decoding differentially coded motion parameters and obtaining the motion parameters by adding the reference warp motion parameters (obtained at 1050) to the differentially coded motion parameters (obtained at 1060) to obtain the motion parameters. In some implementations, a warp motion model type for decoding the current block is decoded from the encoded bitstream. For example, a model identifier (model ID) may be decoded from the encoded bitstream. In some implementations, a relatively short code may be decoded from the encoded bitstream, that indicates that the differential warp motion parameters are zero value, such that decoding the differential warp motion parameters is otherwise omitted. In some implementations, decoding the differential warp motion parameters is omitted and the reference warp motion parameters (obtained at 1050) are used as the warp motion parameters. In some implementations, differentially decoding the motion parameters is omitted and the motion parameters are decoded from the encoded bitstream.

Reconstructed block data is obtained (at 1070). Obtaining the reconstructed block data for the current block may include generating a predicted block in accordance with the motion parameters for the respective block (obtained at 1060), obtaining a reconstructed residual block, which may include decoding encoded residual data from the encoded bitstream, and obtaining the reconstructed block by adding the predicted block and the reconstructed residual block.

In some implementations, a block, or prediction block, in the current superblock, or current superblock group, is decoded using a global motion mode, which includes using the reference, local global, warp motion parameters (obtained at 1050). In some implementations, a translational motion vector derived for a block based on the global parameters can be used as a candidate in dynamic reference lists.

A broken directional line between obtaining reconstructed block data (at 1070) and obtaining motion parameters (at 1060) is shown (at 1075) to indicate that motion parameters, reconstructed block data, or both, are obtained on a per-block basis for the blocks in the current superblock, or the current superblock group.

The reconstructed block data for the current block is included in reconstructed frame data for the current frame, which is included in an output video stream, such as the output video stream 504 shown in FIG. 5, which is output (at 1080).

A broken directional line between output (at 1080) and identifying the current superblock, or the current superblock group, (at 1020) is shown (at 1090) to indicate that identifying a superblock (at 1020), identifying a reference frame (at 1030), obtaining a projected motion field (at 1040), obtaining reference warp motion parameters (at 1050), obtaining motion parameters (at 1060), obtaining reconstructed block data (at 1070), including the reconstructed block data in the output bitstream (at 1080), or a combination thereof, may be performed on a per-superblock, or per-superblock group, basis for the superblocks, or superblock groups, from the current frame.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
obtaining an encoded bitstream;
generating reconstructed frame data, wherein generating the reconstructed frame data includes:
identifying a current frame;
identifying a current reference frame;
identifying a current superblock from the current frame;
obtaining a projected motion field, for the current superblock, using motion data from the current reference frame;
obtaining reference warp motion parameters, for the current superblock, by fitting the projected motion field to a warp motion model;
obtaining, from the encoded bitstream, differential motion parameters for a current block from the current superblock;
obtaining motion parameters for the current block by adding the reference warp motion parameters and the differential motion parameters;
obtaining a predicted block for the current block in accordance with the motion parameters;
obtaining a reconstructed block by adding the predicted block and a reconstructed residual block obtained by decoding residual data for the current block from the encoded bitstream; and
including the reconstructed block in the reconstructed frame data;
including the reconstructed frame data in an output video stream; and
outputting the output video stream.

2. The method of claim 1, wherein:
obtaining the projected motion field includes using motion data from a second reference frame, wherein the motion data from the second reference frame includes a motion vector that intersects the current reference frame.

3. The method of claim 1, wherein:
the current superblock is a 64×64-pixel superblock, a 128×128-pixel superblock, or a 256×256-pixel superblock.

4. The method of claim 1, wherein:
identifying the current superblock includes identifying a current group of superblocks that includes the current superblock;
obtaining the projected motion field includes obtaining the projected motion field for the current group of superblocks; and
obtaining the reference warp motion parameters includes obtaining the reference warp motion parameters for the current group of superblocks.

5. The method of claim 1, wherein:
obtaining the projected motion field includes obtaining, for a respective 8×8 block of the current superblock, zero or more projected motion vectors between the respective 8×8 block and a reference block in the current reference frame.

6. The method of claim 5, wherein:
obtaining a respective projected motion vector includes obtaining, as the respective projected motion vector, a result of multiplying a motion vector from the reference block in the current reference frame by a result of dividing a temporal distance between the current reference frame and the current frame by a temporal distance between the current reference frame and a second reference frame, wherein the current frame is temporally between the current reference frame and the second reference frame.

7. The method of claim 1, wherein:
the warp motion model is a four-parameter warp motion model, a six-parameter warp motion model, or an eight-parameter warp motion model.

8. The method of claim 1, wherein:
fitting the projected motion field includes least-squares regression with respect to the projected motion field.

9. The method of claim 1, wherein:
obtaining the differential motion parameters is omitted; and
obtaining the motion parameters for the current block includes using the reference warp motion parameters as the motion parameters for the current block.

10. The method of claim 1, wherein:
the reference warp motion parameters indicate warped motion between the current reference frame and the current frame.

11. The method of claim 1, wherein:
the current reference frame is from a plurality of reference frames available for decoding the current frame;
obtaining the projected motion field includes obtaining a plurality of projected motion fields that includes the projected motion field, wherein obtaining the plurality of projected motion fields includes obtaining respective projected motion fields on a per-reference frame basis with respect to the plurality of reference frames; and
obtaining the reference warp motion parameters includes obtaining a plurality of reference warp motion parameter sets on a per-projected motion field basis with respect to the plurality of projected motion fields, where a reference warp motion parameter set from the plurality of reference warp motion parameter sets includes the reference warp motion parameters.

12. An apparatus for decoding using local global prediction modes with projected motion fields, the apparatus comprising:
a memory including computer executable instructions for decoding an encoded video stream; and
a processor that executes the instructions to:
obtain an encoded bitstream;
generate reconstructed frame data, wherein to generate the reconstructed frame data the processor executes the instructions to:
identify a current frame;
identify a current reference frame;
identify a current superblock from the current frame;
obtain a projected motion field, for the current superblock, using motion data from the current reference frame;
obtain reference warp motion parameters for the current superblock, wherein, to obtain the reference warp motion parameters, the processor executes the instructions to fit the projected motion field to a warp motion model;
obtain differential motion parameters, for a current block from the current superblock, from the encoded bitstream;
obtain motion parameters, for the current block, wherein, to obtain the motion parameters, the processor executes the instructions to add the reference warp motion parameters and the differential motion parameters;
obtain a predicted block for the current block in accordance with the motion parameters;
obtain a reconstructed block, wherein, to obtain the reconstructed block, the processor executes the instructions to add the predicted block and a reconstructed residual block obtained by decoding residual data for the current block from the encoded bitstream; and
include the reconstructed block in the reconstructed frame data;
include the reconstructed frame data in an output video stream; and
output the output video stream.

13. A non-transitory computer-readable storage medium having stored thereon an encoded bitstream, wherein the encoded bitstream is configured for decoding by operations comprising:
obtaining the encoded bitstream;
generating reconstructed frame data, wherein generating the reconstructed frame data includes:
identifying a current frame;
identifying a current reference frame;
identifying a current superblock from the current frame;
obtaining a projected motion field, for the current superblock, using motion data from the current reference frame;
obtaining reference warp motion parameters, for the current superblock, by fitting the projected motion field to a warp motion model;
obtaining, from the encoded bitstream, differential motion parameters for a current block from the current superblock;
obtaining motion parameters for the current block by adding the reference warp motion parameters and the differential motion parameters;
obtaining a predicted block for the current block in accordance with the motion parameters;
obtaining a reconstructed block by adding the predicted block and a reconstructed residual block obtained by decoding residual data for the current block from the encoded bitstream; and
including the reconstructed block in the reconstructed frame data;
including the reconstructed frame data in an output video stream; and
outputting the output video stream.

14. The non-transitory computer-readable storage medium of claim 13, wherein:
obtaining the projected motion field includes using motion data from a second reference frame, wherein the motion data from the second reference frame includes a motion vector that intersects the current reference frame.

15. The non-transitory computer-readable storage medium of claim 13, wherein:
identifying the current superblock includes identifying a current group of superblocks that includes the current superblock;
obtaining the projected motion field includes obtaining the projected motion field for the current group of superblocks; and
obtaining the reference warp motion parameters includes obtaining the reference warp motion parameters for the current group of superblocks.

16. The non-transitory computer-readable storage medium of claim 13, wherein:
obtaining the projected motion field includes obtaining, for a respective 8×8 block of the current superblock, zero or more projected motion vectors between the respective 8×8 block and a reference block in the current reference frame.

17. The non-transitory computer-readable storage medium of claim 16, wherein:
obtaining a respective projected motion vector includes obtaining, as the respective projected motion vector, a result of multiplying a motion vector from the reference block in the current reference frame by a result of dividing a temporal distance between the current reference frame and the current frame by a temporal distance between the current reference frame and a second reference frame, wherein the current frame is temporally between the current reference frame and the second reference frame.

18. The non-transitory computer-readable storage medium of claim 17, wherein:
fitting the projected motion field includes least-squares regression with respect to the projected motion field.

19. The non-transitory computer-readable storage medium of claim 13, wherein:
obtaining the differential motion parameters is omitted; and
obtaining the motion parameters for the current block includes using the reference warp motion parameters as the motion parameters for the current block.

20. The non-transitory computer-readable storage medium of claim 13, wherein:
the reference warp motion parameters indicate warped motion between the current reference frame and the current frame.
